(19) United States
(12) Patent Application Publication
(10) Pub. No.: US 2007/0127273 A1
(43) Pub. Date: Jun. 7, 2007

(54) DC CLIP LAMP

(76) Inventor: Lee-Hsueh Tsai, Sihu Township (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/164,696

(22) Filed: Dec. 1, 2005

(51) Int. Cl. H01R 33/00

(52) U.S. Cl. 362/646; 362/652

(57) ABSTRACT

A DC clip lamp comprises a lamp assembly and a transformer. The lamp assembly includes a lampstand and a LED light bulb, a power line is connected to the bottom of the clip lamp, a controlling member is connected to the end of the power line which includes a power socket and a switch. The transformer is connected with a power line, one end of the power line is formed with a plug which is inserted in the power socket of the controlling member. Therefore, alternating current (AC) will be changed into direct current (DC) by the transformer, and the LED light bulb will be controlled by the controlling member.

### BACKGROUND OF THE INVENTION

1. Field of the Invention

The present invention relates to a lamp, and more particularly to a DC clip lamp that is power saving and produces less heat.

2. Description of the Prior Art

A conventional clip lamp structure as shown in FIG. 1, comprises a lamp assembly 10 and a power line 20. The lamp assembly 10 has a lampstand 11 and a tungsten filament light bulb 12. On the outer edge of the lamp assembly 10 is arranged a springy clipping member 13. One end of the power line 20 is connected with the bottom of the lampstand 11, the other end of the power line 2 is formed with a plug 21, and a controlling member 22 is connected in the middle of the power line 2. Therefore, the lampstand 11 can be clipped to a predetermined position by the springy clipping member 13, and the controlling member 22 controls the tungsten filament light bulb 12.

However, the conventional clip lamp has some disadvantages as follows:

First, the conventional clip lamp structure should use alternative current and tungsten filament light bulb, and the tungsten filament light bulb 12 produces light and heat, so the voltage and the electric current that needed are large, according to the principle of the power (capacity of electricity)=V (voltage)*I (electric current), thereby it is uneconomical and power wasting.

Second, after a period of use, the tungsten filament light bulb 12 will burn out, and it only can produce monochromatic light.

The present invention has arisen to mitigate and/or obviate the afore-described disadvantages.

### SUMMARY OF THE INVENTION

A DC clip lamp in accordance with the present invention comprises a lamp assembly having a lampstand and a LED light bulb, and a transformer. A springy clip member is mounted on the outer edge of the lampstand, and a power line is connected to the bottom of the clip lamp, a controlling member is connected to the end of the power line that includes a power socket, a switch, a photosensitive resistance and an alterable resistance. The transformer is connected with a power line, one end of the power line is formed with a plug which is inserted in the power socket of the controlling member. While using, the transformer will change the alternating current (AC) into direct current (DC), so that the LED light bulb will be controlled by the alterable resistance to flash and produce different colored lights according to a predetermined program.

The primary objective of the present invention is to provide a LED light bulb, wherein the transformer will change the alternating current (AC) into direct current (DC), the voltage and the electric current that needed are small, thereby the electricity will be saved.

Another objective of the present invention is to provide a LED light bulb, which is not only safe, has long life, produces less heat, but also can produce different colored lights.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a conventional clip lamp;

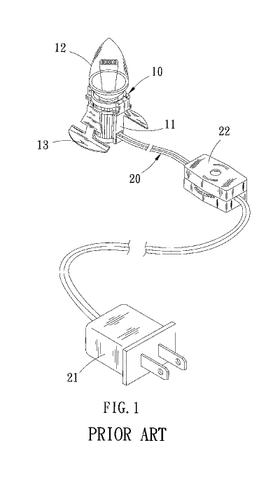

FIG. 2 is an assembly view of a clip lamp in accordance with the present invention;

FIG. 3 is an exploded view of the clip lamp in accordance with the present invention;

FIG. 4 is showing a circuit view in accordance with the present invention;

FIG. 5 is a perspective view of the clip lamp in accordance with the present invention;

FIG. 6 is an assembly view of a clip lamp in accordance with another embodiment of the present invention;

FIG. 7 is an exploded view of a clip lamp in accordance with another embodiment of the present invention; and

FIG. 8 is a perspective view of the clip lamp in accordance with another embodiment of the present invention.

### DETAILED DESCRIPTION OF THE PREFERRED EMBODIMENTS

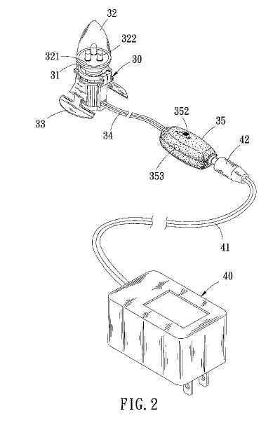

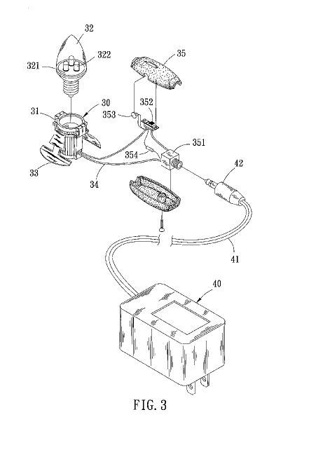

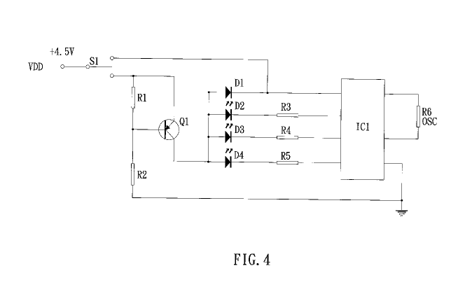

Referring to FIGS. 2-4 a DC clip lamp in accordance with the present invention comprises a lamp assembly 30 having a lampstand 31 and a LED light bulb 32, and a transformer 40. A circuit board 321 and a plurality of LEDs 322 of different colors are arranged in the LED light bulb 32, a springy clip member 33 is mounted on the outer edge of the lampstand 31, and a power line 34 is connected to the bottom of the clip lamp. A controlling member 35 is connected to the end of the power line 34, which includes a power socket 351, a switch 352, a photosensitive resistance 353 and an alterable resistance 354. The transformer 40 is connected with a power line 41, one end of the power line 41 is formed with a plug which is inserted in the power socket 351 of the controlling member 35.

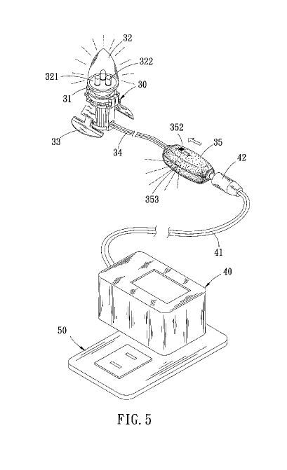

Referring to FIG. 5, the transformer 40 is inserted in a socket 50 on the wall, so that alternating current (AC) will be changed to direct current (DC) of 4.5V, and the transformer 40 cooperate with the photosensitive resistance 353 for sensitizing under the control of the switch 352 of the controlling member 35 is cooperated. In daytime, when the switch 352 is turned on, the photosensitive resistance 353 will be closed when receiving the light source information, so as to save electricity. When the light is dark to a certain degree, the photosensitive resistance 353 will turn on the power, so that the LEDs 322 of different colors in the LED light bulb 32 will be controlled by the alterable resistance 354 to flash according to a predetermined program.

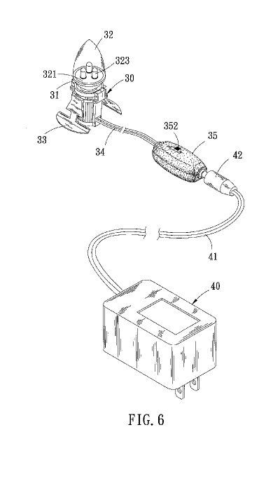

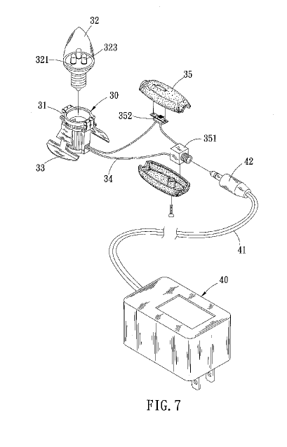

Referring to FIGS. 6 and 7, which includes the lamp assembly 30 having the lampstand 31 and the LED light bulb 32, and the transformer 40. A circuit board 321 and a plurality of LEDs 323 of the same color are defined in the LED light bulb 32, the springy clip member 33 is mounted on the outer edge of the lampstand 31, and the power line 34 is connected to the bottom of the clip lamp. The controlling member 35 is connected to the end of the power line 34 and includes the power socket 351, and the switch 352. The transformer 40 is connected with the power line 41, one end of the power line 41 is formed with the plug 42 which is inserted in the power socket 351 of the controlling member 35.

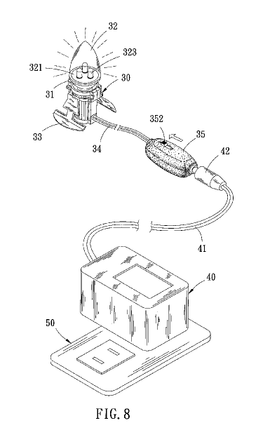

Referring to FIG. 8, the transformer 40 is inserted in the socket 50 on the wall, so that alternating current (AC) will be changed to direct current (DC) of 4.5V. The power source by the switch 352 of the controlling member 35 serves to turn on the power, making the LED 323 inside the LED light bulb 32 burn constantly

Therefore, this invention has some advantages as follows:

First, it is power saving due to the use of LED light bulb 32, plus the transformer 40 can change alternating current (AC) into direct current (DC).

Second, the LED light bulb 32 is not only safe, has long life, but also produces less heat. In addition, the alterable resistance 354 can enable the light bulb to produce different colored lights.

While we have shown and described various embodiments in accordance with the present invention, it should be clear to those skilled in the art that further embodiments may be made without departing from the scope of the present invention.

What is claimed is:

1. A DC clip lamp comprising a lamp assembly and a transformer, the lamp assembly having a lampstand and a LED light bulb, on an outer edge of the lamp assembly is mounted a springy clipping member, a power line is connected to a bottom of the clipping lamp, the transformer is connected with a power line having an end connected with a plug;
an end of the power line of the lamp assembly is connected with a controlling member, the controlling member includes a power socket, a switch, a photosensitive resistance and an alterable resistance, the plug of the transformer is inserted in the power socket, so that the LED light bulb will be controlled by the alterable resistance to flash and produce different colored lights according to a predetermined program.

2. The DC clip lamp as claimed in claim 1, wherein a circuit board and a plurality of LEDs of different colors are arranged in the LED light bulb.

3. A DC clip lamp comprising a lamp assembly and a transformer, the lamp assembly having a lampstand and a LED light bulb, on an outer edge of the lamp assembly is arranged a springy clipping member, a power line is connected to a bottom of the clip lamp, the transformer is connected with a power line having an end connected with a plug;
an end of the power line of the lamp assembly is connected with a controlling member that includes a power socket and a switch, the plug of the transformer is inserted in the power socket, so that the LED light bulb will burn constantly after the controlling member turns on the power.

4. The DC clip lamp as claimed in claim 3, wherein a circuit board and a plurality of LEDs of different colors are arranged in the LED light bulb.
